(19) United States
(12) Patent Application Publication
(10) Pub. No.: US 2023/0302802 A1
(43) Pub. Date: Sep. 28, 2023

(54) METHOD FOR MANUFACTURING LIQUID EJECTION HEAD AND LIQUID EJECTION HEAD

(71) Applicant: CANON KABUSHIKI KAISHA, Tokyo (JP)

(72) Inventor: KOJI SASAKI, Chiba (JP)

(21) Appl. No.: 18/172,425

(22) Filed: Feb. 22, 2023

(30) Foreign Application Priority Data
Mar. 23, 2022 (JP) 2022-046878

(51) Int. Cl. B41J 2/14; B41J 2/16

(52) U.S. Cl. CPC B41J 2/1433; B41J 2/162; B41J 2/1642

(57) ABSTRACT

A method for manufacturing a liquid ejection head including a substrate that includes a liquid supply port on a first surface, a liquid ejection port on a second surface, and a flow path that connects the supply port and the ejection port to each other such that the supply port and the ejection port do not communicate with each other in a direction intersecting with the first surface and the second surface, comprises: a liquid repellent film forming step of forming a liquid repellent film on the substrate; a masking step of covering a surface of the liquid repellent film on the second surface; and a plasma treatment step of generating plasma from the first surface toward the second surface to remove the liquid repellent film, wherein a portion of the liquid repellent film which remains inside the ejection port after the plasma treatment step is hydrophilized.

### BACKGROUND OF THE INVENTION

### Field of the Invention

The present invention relates to a liquid ejection head that performs recording on a recording medium by ejecting a liquid using a substrate bonded body in which a plurality of substrates are bonded and an ejection energy generating element.

### Description of the Related Art

Microfabricated structures of silicon are widely used in the field of MEMS and functional devices of electromechanical systems. One example thereof is a liquid ejection head that ejects a liquid. As a usage example thereof, there is a liquid ejection head of a liquid ejection recording type which performs recording by causing ejection droplets to land on a recording medium. A liquid ejection head of a liquid ejection recording type includes a substrate provided with an energy generating element that generates energy used for ejecting a liquid and an ejection port that ejects ink supplied from a liquid supply port provided on the substrate.

In recent years, in liquid ejection heads, improved printing performance such as high resolution and high-speed printing and reduction in the size and high density in manufacturing have been required. Therefore, a silicon substrate is used for a flow path forming substrate and a nozzle substrate, and the substrates are bonded with an adhesive.

In a droplet ejection head, ink may adhere to the front surface of the nozzle substrate due to the influence of ink mist or the like when ink droplets are ejected. If ink adheres to the front surface of the nozzle substrate, it may affect the ejection of ink droplets from the ejection port, thereby causing variations in an ejection direction of the ink droplets. Therefore, in general, a liquid repellent film is formed on the front surface of the nozzle substrate to prevent ink from adhering to the periphery of the ejection port, thereby improving ejection characteristics of ink droplets.

Further, in a case where a water repellent film is formed on the front surface of the nozzle substrate on which the ejection port opens, the water repellent film also adheres to the inside of a nozzle. When the water repellent film is formed inside the nozzle, a meniscus position is located inside the nozzle, and thus a droplet volume and an ejection direction become unstable, and print quality deteriorates. Therefore, methods for removing the water repellent film adhering to the inside of the nozzle have been examined. For example, in Japanese Patent Application Laid-open No. 2015-150768 below, as a method for removing the water repellent film that wraps around and adheres to the inside of the nozzle, a method in which the front surface of the nozzle substrate is protected with a film and the inside water repellent film is removed from the back surface side of the nozzle substrate using plasma is described.

### SUMMARY OF THE INVENTION

The method described in Japanese Patent Application Laid-open No. 2015-150768 is based on the premise that a flow path substrate is bonded after plasma treatment, and the plasma treatment is performed from the back surface side of the nozzle substrate in a form in which the ejection port on the front surface of the nozzle substrate and an opening portion on the back surface side thereof are formed to linearly penetrate the substrate in a thickness direction thereof. In addition, a liquid repellent film made of perfluoropolyether (PFPE) has a problem of a low removal effect. In the case of a configuration having a bent liquid flow path due to the bonding of substrates or the like, the removal becomes even more difficult. In a case where the water repellent film made of PFPE adhered to the inside of the nozzle is removed via the bent liquid flow path, the removal efficiency is reduced compared to a configuration in which the central axis of an opening passes through linearly, which is a problem.

An object of the present invention is to provide a liquid ejection head with good ejection reliability.

In order to achieve the above object, according to the present invention, there is provided a method for manufacturing a liquid ejection head including a substrate,
the substrate including a first surface, a second surface on a side opposite to the first surface, a liquid supply port that opens on the first surface, a liquid ejection port that opens on the second surface, and a flow path that connects the supply port and the ejection port to each other such that the supply port and the ejection port do not linearly communicate with each other in a direction intersecting with the first surface and the second surface,
the method for manufacturing a liquid ejection head including the substrate comprising:
a liquid repellent film forming step of forming a liquid repellent film made of perfluoropolyether on a front surface of the substrate;
a masking step of covering a surface of the liquid repellent film formed on the second surface in the liquid repellent film with a protective member; and
a plasma treatment step of generating plasma from a side of the first surface toward a side of the second surface through the flow path to remove the liquid repellent film,
wherein, in the plasma treatment step, a portion of the liquid repellent film which remains inside the ejection port of the substrate after the plasma treatment step is hydrophilized.
In order to achieve the above object, according to the present invention, there is provided a liquid ejection head including a substrate,
wherein the substrate includes
   a first surface,
   a second surface on a side opposite to the first surface,
   a liquid supply port that opens on the first surface,
   a liquid ejection port that opens on the second surface,
   a flow path that connects the supply port and the ejection port to each other such that the supply port and the ejection port do not linearly communicate with each other in a direction intersecting with the first surface and the second surface, and
   a liquid repellent film formed on the second surface,
wherein a film formed inside the ejection port of the substrate has higher hydrophilicity than the liquid repellent film.

According to the present invention, it is possible to provide a liquid ejection head with good ejection reliability.

Further features of the present invention will become apparent from the following description of exemplary embodiments with reference to the attached drawings.

### BRIEF DESCRIPTION OF THE DRAWINGS

FIG. 1 is a schematic cross-sectional view showing an example of a liquid ejection head according to an embodiment of the present invention;

FIGS. 2A to 2D are schematic views showing an example of the embodiment of the present invention;

FIG. 3 is a schematic view showing an example of the embodiment of the present invention;

FIG. 4 is a table showing a relationship between an oxygen plasma treatment time, a pure water contact angle, and surface composition;

FIGS. 5A and 5B are graphs of a contact angle and an F atom concentration with respect to an ashing time;

FIG. 6 is a perspective view showing a liquid ejection head according to the embodiment of the present invention;

FIG. 7 is an exploded perspective view showing a component configuration of the liquid ejection head according to the embodiment of the present invention; and

FIG. 8 is a schematic cross-sectional view showing an internal structure of the liquid ejection head according to the embodiment of the present invention.

### DESCRIPTION OF THE EMBODIMENTS

A mode for carrying out this invention will be exemplarily described in detail below on the basis of an embodiment with reference to the drawings. The dimensions, materials, shapes, and relative arrangement of components described in this embodiment should be appropriately changed according to a configuration of a device to which the invention is applied and various conditions. Further, not all combinations of features described in the present embodiment are essential for the solution means of the present invention. Constituent elements described in the embodiment are merely examples and the scope of the present invention is not intended to be limited only to them.

In order to solve the above-described problems, the present inventors have made intensive studies, and as a result, have been able to obtain the following findings. That is, perfluoropolyether (PFPE) can reduce water repellency even if a part of a water repellent film remains. Therefore, the meniscus position during droplet ejection can be stabilized without completely removing the water repellent film inside the ejection port. In addition, even in the case of a substrate having a bent flow path formed by bonding or the like, plasma treatment can be applied to the water repellent film adhering to the inside of the ejection port through the inside of the liquid flow path. Therefore, the water repellent film can be formed after completing the flow path substrate by bonding or the like.

### Overview of Liquid Ejection Head

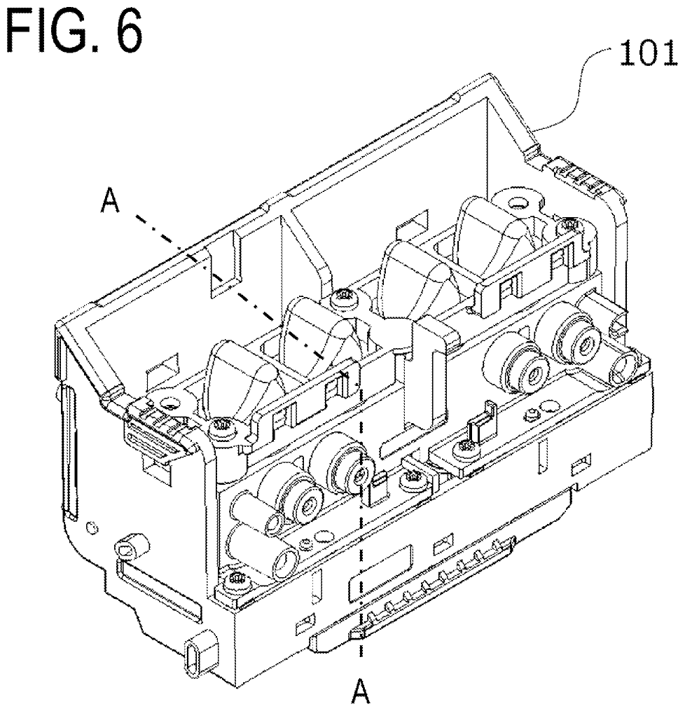

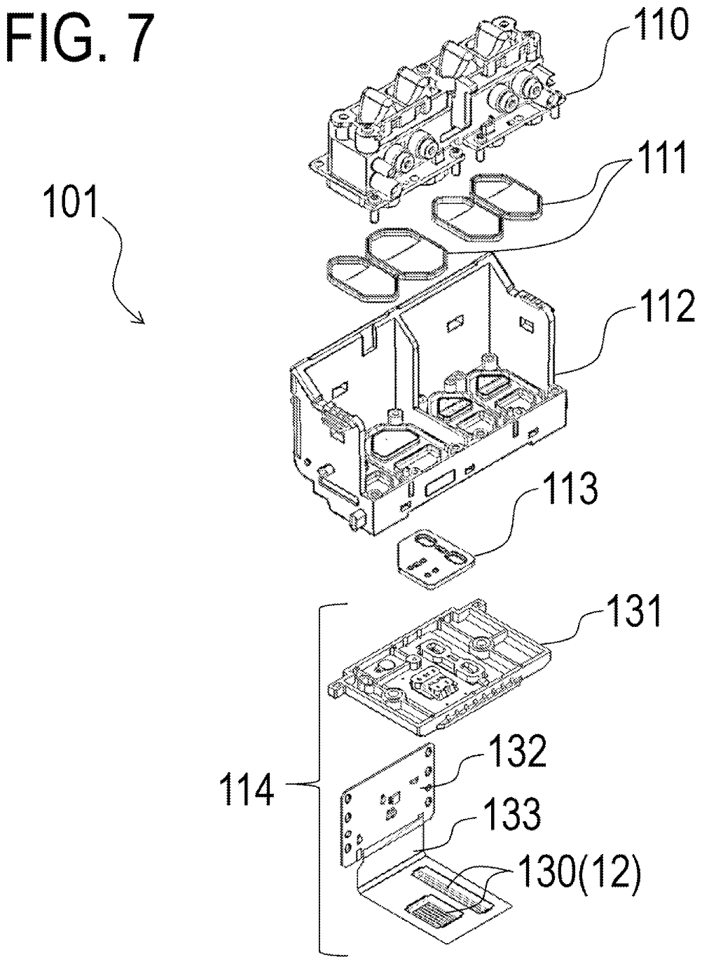

FIG. 6 shows a state after assembly of a liquid ejection head 101 for ejecting a liquid such as ink in the embodiment of the present invention, and FIG. 7 is an exploded view showing a configuration before assembly of the liquid ejection head 101 of FIG. 6. The liquid ejection head 101, which will be described below, is configured as an ink jet recording head used in an inkjet printer or the like as an image recording apparatus to record a desired image on a recording material by ejecting ink as an image recording liquid onto the recording material. However, the present invention can be suitably applied to usages other than the ink jet recording head.

First, an outline of the overall configuration of the liquid ejection head 101 will be described. The illustrated liquid ejection head 101 ejects, for example, a black ink and six color inks other than black as recording liquids. The black ink and the color inks may be collectively referred to as a recording liquid.

The liquid ejection head 101 is constituted by a sub-tank unit 110, a first elastic member 111, a head main body portion 112, and a recording element unit 114. At this time, the first elastic member 111 is sandwiched between the sub-tank unit 110 and the head main body portion 112 and seals them by screwing the outer peripheral portions thereof. Further, a second elastic member 113 is sandwiched between the head main body portion 112 and the recording element unit 114 and seals them by screwing the outer peripheral portions thereof. The recording element unit 114 is constituted by a support member 131, an electric board 132, an electric wiring board 133, and a recording element 130.

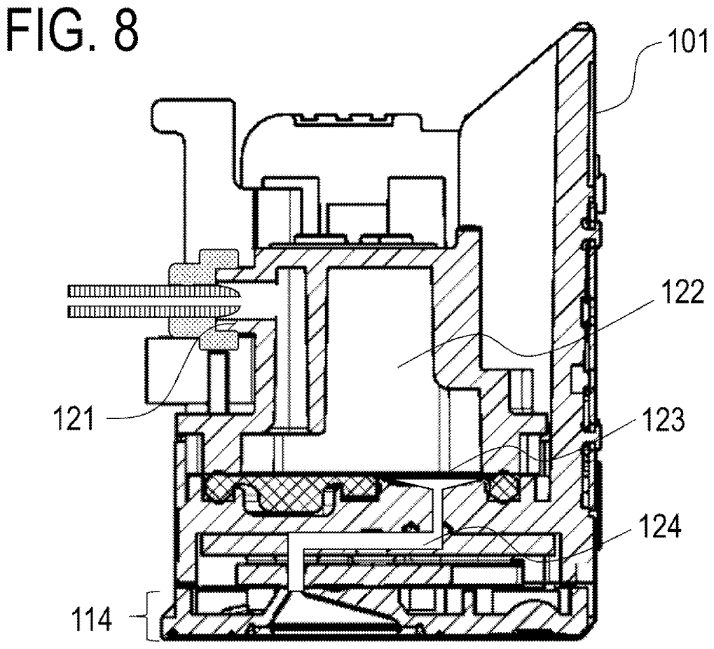

FIG. 8 shows an A-A cross section of the liquid ejection head 101 of FIG. 6 and shows an ink supply path inside the liquid ejection head 101. Ink is supplied to the inside of the liquid ejection head 101 through a joint portion 121 from an external ink tank (not shown) (for example, a liquid storage portion provided in a printer main body). The ink supplied to the inside of the liquid ejection head 101 passes through an ink chamber 122 and a filter 123 and reaches the recording element unit 114 via an internal flow path 124.

### Step of Forming Bonded Substrate

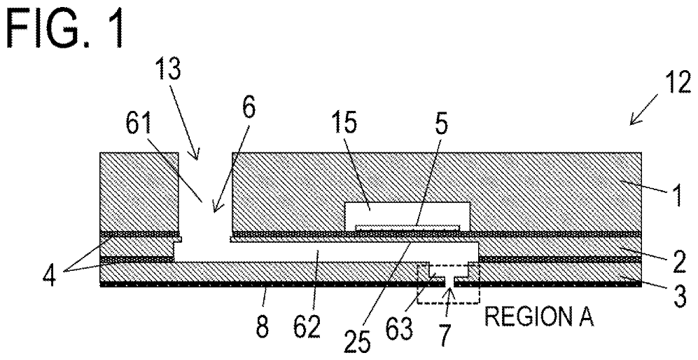

FIG. 1 is a schematic cross-sectional view showing a cross-sectional configuration of a nozzle plate 12 that is a substrate portion constituting the recording element 130 that is a liquid ejection element in the liquid ejection head 101.

The nozzle plate 12 includes a flow path substrate 1, an actuator substrate 2, and a nozzle substrate 3, and the substrates are bonded via an adhesive 4. The nozzle plate 12 has a supply port 13 through which ink is supplied on a surface of the flow path substrate 1 on a side opposite to a bonding surface with the actuator substrate 2, which is a first surface. Further, the nozzle plate 12 has an ejection port 7 for ejecting ink on a surface of the nozzle substrate 3 on a side opposite to a bonding surface with the actuator substrate 2, which is a second surface on a side opposite to the first surface. The nozzle plate 12 has a liquid flow path portion 6 as an ink flow path that connects the supply port 13 and the ejection port 7 to each other. The liquid flow path portion 6 is configured such that the supply port 13 and the ejection port 7 do not linearly communicate with each other in a thickness direction of the nozzle plate 12 (a direction intersecting with, typically a direction perpendicular to, the first surface and the second surface of the nozzle plate 12). That is, the liquid flow path portion 6 includes a flow path portion (a liquid flow path portion 62) that extends in a direction intersecting with the thickness direction of the nozzle plate 12, typically a direction parallel to the first surface and the second surface of the nozzle plate 12. Therefore, the liquid flow path portion 6 has a flow path configuration in which the supply port 13 and the ejection port 7 do not overlap each other when viewed in the thickness direction of the nozzle plate 12 (the direction perpendicular to the substrate surface).

The flow path configuration of the liquid flow path portion 6 shown here is merely an example. For example, the flow path configuration may include a plurality of flow path portions extending in the direction intersecting with the thickness direction of the nozzle plate 12 (the direction parallel to the surface of the nozzle plate 12). Moreover, the flow path configuration may include branch flow paths extending to branch off from each of a plurality of ejection ports 7. That is, as will be described later, a substrate having a flow path configuration that makes it difficult to remove a liquid repellent film using ions in plasma treatment is suitable as a target to which the present invention is applied.

On the front surface of the actuator substrate 2, a piezoelectric element 5 is disposed as an example of an energy generating element that generates energy when ink is ejected. As the piezoelectric element 5, for example, a lead zirconate titanate (PZT) film formed by a sol-gel method or a sputtering method can be applied. Such a piezoelectric element 5 is made of a sintered body of metal oxide crystals. The piezoelectric element 5 is provided on a film portion 25, which is a region thinned by forming a recess portion for forming a second liquid flow path portion 62 in the actuator substrate 2.

The flow path substrate 1 made of silicon (Si) is disposed to cover the piezoelectric element 5 with a recess portion forming a cavity 15 and is bonded to the front surface of the actuator substrate 2 via the adhesive 4. Further, the nozzle substrate 3 is bonded to the back surface of the actuator substrate 2 via the adhesive. The ink tank (not shown) is disposed as the liquid storage portion on the surface of the flow path substrate 1 on a side opposite to the bonding surface with the actuator substrate 2, and the supply port 13 opens on that surface. A first liquid flow path portion 61 including the supply port 13 is formed in the flow path substrate 1 to penetrate the flow path substrate 1. Further, the second liquid flow path portion 62 is formed between the actuator substrate 2 and the nozzle substrate 3. Further, the ejection port 7 is formed in the nozzle substrate 3 to penetrate the nozzle substrate 3. In the nozzle plate 12, a liquid flow path through which ink is supplied from the ink tank (not shown) to the ejection port 7 is formed by the liquid flow path portion 6 constituted by the first liquid flow path portion 61 and the second liquid flow path portion 62. That is, the first liquid flow path portion 61 communicates with the second liquid flow path portion 62 provided between the actuator substrate 2 and the nozzle substrate 3 and is connected to the ejection port 7 of the nozzle substrate 3. Ink supplied from the ink tank (not shown) passes through the liquid flow path portion 6 and is ejected from the ejection port 7 by receiving energy generated by the piezoelectric element 5. The ink ejected from the ejection port 7 adheres to an image recording surface of the recording material disposed facing the ejection port 7 to form an image on the recording material.

When a drive voltage is applied to the piezoelectric element 5 from a drive IC (not shown), the piezoelectric element 5 deforms due to an inverse piezoelectric effect. Due to the deformation of the piezoelectric element 5 caused by the application of a pull-push-pull waveform drive voltage, the film portion 25, which is a part of a wall portion forming the second liquid flow path portion 62 in the actuator substrate 2, elastically deforms. As a result, the inside of the cavity 15 is expanded and contracted to change the volume of the liquid flow path portion 6, and when the liquid in the liquid flow path is pressurized, a meniscus is formed on the front surface of the ejection port 7. After that, the liquid pressurized by the contracting is ejected as droplets from the ejection port 7.

Here, it is known that if the inside of a nozzle is water repellent, a meniscus is formed at the back of the nozzle, and thus the ejection volume and the ejection direction of the fluid protruding from the ejection port 7 become unstable.

### Method for Forming Liquid Repellent Film

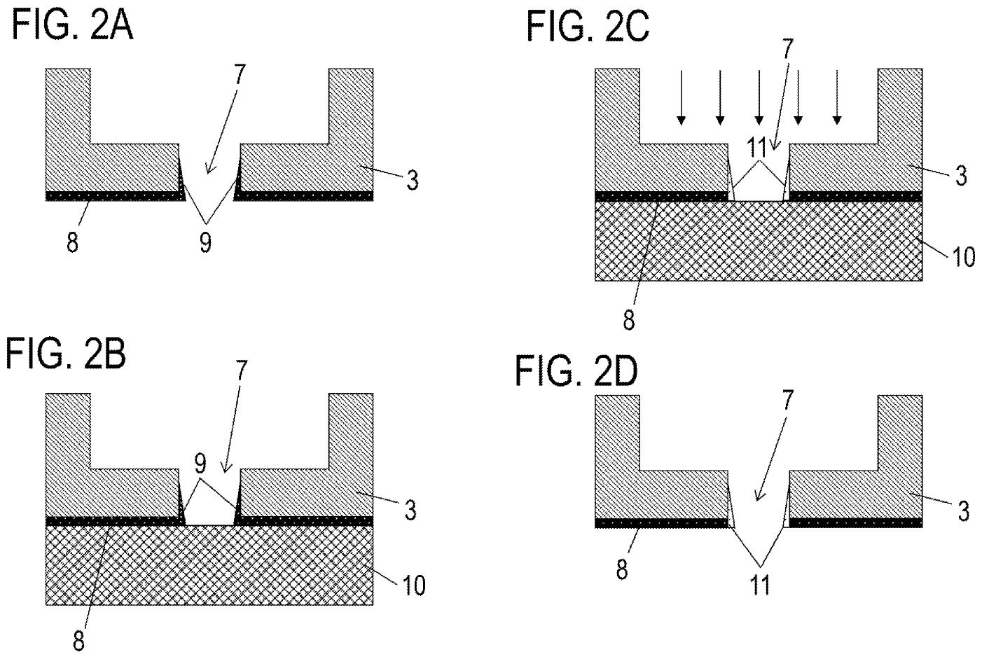

FIGS. 2A to 2D are schematic cross-sectional views showing a method for forming a liquid repellent film of a liquid droplet ejection head according to the embodiment of the present invention in order of steps, in which a region A shown in FIG. 1 is enlarged.

The formation of the liquid repellent film is performed through the following steps on the substrates bonded via the adhesive.
(1) A liquid repellent film forming step of forming a water repellent film as the liquid repellent film on the surface of the nozzle plate 12 including the surface inside the liquid flow path portion 6
(2) A surface protection step of forming a protective member 10 on the front surface (the second surface) of the nozzle substrate 3
(3) A plasma treatment step of removing the water repellent film except for a portion covered with the protective member 10 by plasma treatment and making the water repellent film remaining inside the ejection port 7 of the nozzle substrate 3 hydrophilic
(4) A protective member peeling step of peeling off the protective member 10

### (1) Water Repellent Film Forming Step

As shown in FIG. 2A, a water repellent film 8 made of perfluoropolyether (PFPE) is formed on the nozzle substrate 3 in which a plurality of ejection ports 7 are formed. As the nozzle substrate 3, it is preferable to use a nozzle substrate in which the flow path substrate 1 and the actuator substrate 2 are bonded. The front surface of the nozzle substrate 3 may be cleaned before performing the water repellent formation. For example, plasma treatment, ion beam cleaning, UV ozone cleaning, or the like can be used.

The water repellent film 8 can be formed by, for example, a physical vapor phase method such as a vapor deposition method. In the vapor deposition method, the substrate is disposed in a vacuum chamber, and a water repellent material is vaporized in the vacuum chamber. Further, the water repellent film can also be formed by a liquid phase method such as a roller coating method, a dipping treatment method, or a spin coating method.

Here, since the ejection port 7 is formed in the nozzle substrate 3, the water repellent film 8 is also formed inside the ejection port 7 of the nozzle substrate 3. In order to stabilize the meniscus, it is necessary to leave the water repellent film 8 on the front surface of the nozzle substrate 3 and remove a water repellent film 9 formed inside the ejection port 7 or at least make a water repellent film 9 hydrophilic.

### (2) Protective Member Forming Step (Masking Step)

Next, as shown in FIG. 2B, a protective member 10 is formed on a portion where the water repellent film 8 is desired to remain.

The protective member 10 is not particularly limited, and a resin material, tape, or the like can be appropriately selected. If the protective member 10 comes off around the ejection port 7, the water repellent film 8 on the front surface of the nozzle substrate 3 will be hydrophilized due to the subsequent plasma treatment. In this case, the meniscus at the ejection port 7 becomes unstable, resulting in an ejection failure. Therefore, in order to prevent the protective member 10 from coming off, it is also possible to attach the protective member 10 under reduced pressure.

### (3) Plasma Treatment Step

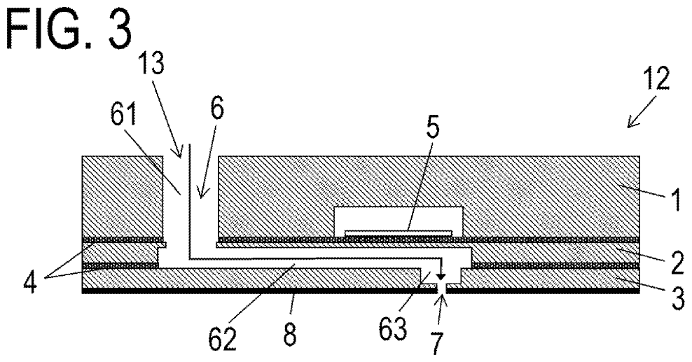

Next, as shown in FIG. 2C, the water repellent film 9 (FIG. 2B) inside the ejection port 7 of the nozzle substrate 3 is hydrophilized by plasma treatment from a side of the flow path substrate 1 and is altered into a residual film 11 having higher hydrophilicity than the water repellent film 8. Here, FIG. 3 is a schematic cross-sectional view showing a path of plasma through the entire nozzle plate 12, that is, the entire liquid flow path portion 6.

As an example of a plasma treatment method, the nozzle plate 12 is set in a vacuum pressure chamber, and oxygen plasma is generated from a gas containing oxygen atoms. As shown in FIG. 3, the plasma reaches the ejection port 7 from the flow path substrate 1 via the actuator substrate 2. For plasma generation, a microwave type device, a remote plasma type device, or the like can be used depending on the purpose.

The plasma contains ions and radicals, and it is known that generally the ions have a high straightness and a high reaction rate, whereas the radicals have a isotropy and the reaction rate thereof depends on a temperature. As in the substrate in Japanese Patent Application Laid-open No. 2015-150768, in the case of a substrate in which the supply port and the ejection port of the liquid flow path communicate with each other linearly (straight in the direction intersecting with the substrate surface), it is preferable to make the plasma go straight in removing the water repellent film in the flow path, and thus it is efficient to use the ions. On the other hand, as in the substrate of the present embodiment, in the case of a substrate in which the liquid flow path is a bent flow path, that is, a flow path in which the supply port and the ejection port do not linearly communicate with each other, a sufficient effect of removing the water repellent film in the flow path cannot be expected with the ions that go straight, and it is preferable to use an effect of radicals.

Further, in order to enhance an effect of ions, a method for increasing energy by applying a bias to the substrate is used, but in the case of the substrate having a configuration in which the effect of removing the water repellent film with ions is low, as in the bent flow path, the effect of bias application cannot be expected. Rather, applying a bias to the substrate may cause damage due to electric charges, or an adverse effects due to temperature rise of the substrate, such as deterioration of semiconductor characteristics.

Therefore, in the plasma treatment in which plasma is generated to pass through the bent flow path as in the substrate of the present embodiment, it is preferable to eliminate bias application to the substrate and not to rely on ion assist. As a result, it becomes possible to move radicals isotropically with the reaction of radicals as a main reaction. Regarding a treatment temperature for obtaining the effect of radicals, a lower limit temperature is related to a treatment speed, and thus a throughput is considered, and an upper limit temperature is determined from the viewpoint of the heat resistance of the protective member 10 to be used. A predetermined treatment temperature for activating radicals is preferably about 5° C. to 70° C., and more preferably 10° C. to 50° C., for example.

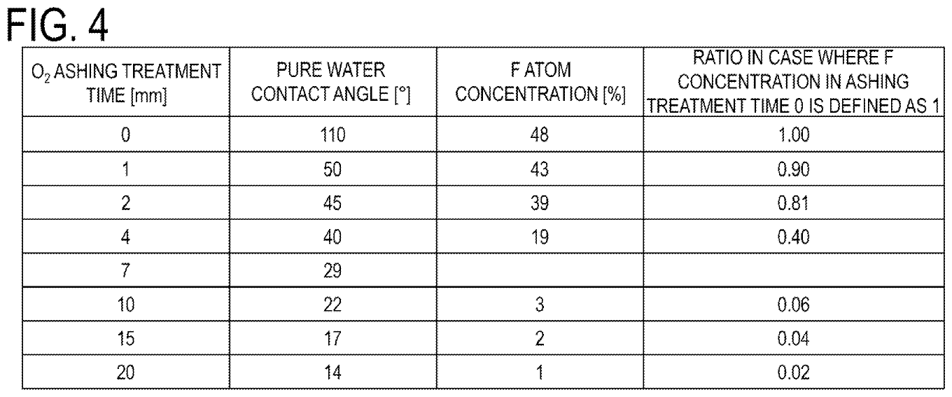

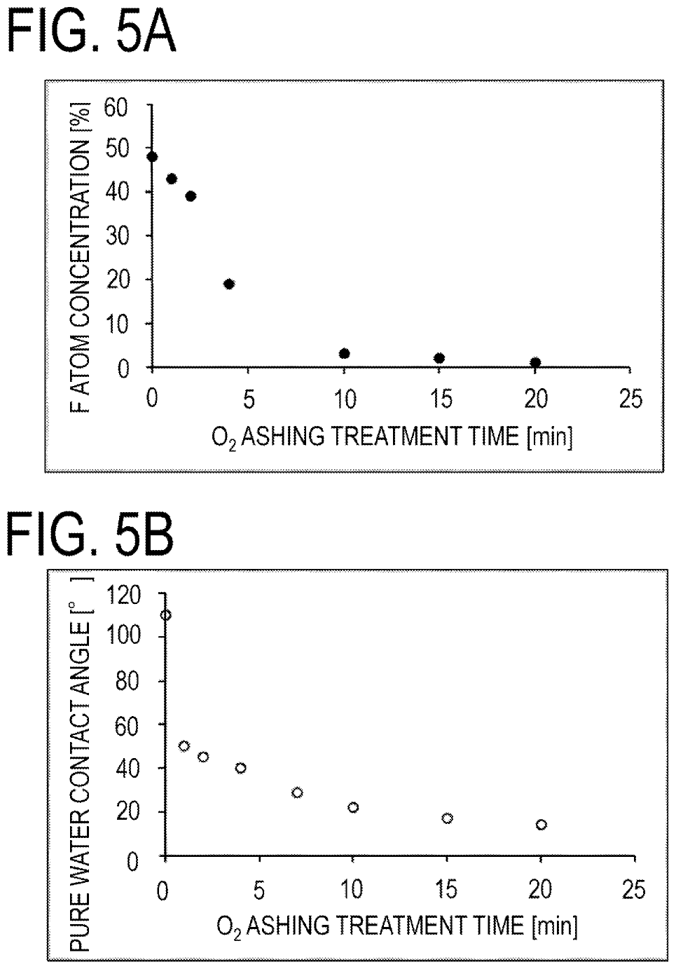

FIGS. 4 and 5A and 5B show a relationship between an oxygen plasma treatment time, a pure water contact angle, and surface composition of a water repellent film made of perfluoroether when a substrate application bias is 0 W, a substrate heating temperature is 16° C., and an oxygen flow rate is 30 sccm, which is obtained as a result of examination by the inventors. As shown in FIGS. 4 and 5A and 5B, it was found that even if some fluorine remains on the surface, the water repellent film can be made sufficiently hydrophilic. It is assumed that oxygen ashing cuts an ether bond of the perfluoroether and converts the terminal to —OH, thereby making the water repellent film hydrophilic. Since the contact angle of the water repellent film is changed, the contact angle can be controlled regardless of the contact angle of a base film itself of the water repellent film.

### (4) Protective Film Peeling Step (Masking Removing Step)

Finally, as shown in FIG. 2D, the protective member 10 is peeled off from the nozzle substrate 3. Then, using the nozzle plate 12 from which the protective member 10 has been peeled off, the liquid ejection head 101 is manufactured (FIGS. 6 to 8). In a case where a micro tape is used as the protective member 10, a releasability can be improved by applying heat of about 60° C. when peeling off the tape.

### Example 1

As an example of the present invention, a nozzle plate 12 shown in FIG. 1 was manufactured. As shown in FIG. 1, the nozzle plate 12 is manufactured by bonding the flow path substrate 1, the actuator substrate 2, and the nozzle substrate 3, which are made of a silicon substrate, via an adhesive. In the present embodiment, a plurality of ejection ports 7 are arranged on the front surface of the nozzle substrate 3. Each substrate is processed by dry etching. The shapes of the liquid flow path portion 6 and the ejection port 7 are not limited to those illustrated here. 10 nm of a SiO₂ film (not shown) was formed on the front surface of the nozzle substrate 3 by a vapor deposition method in consideration of adhesion with the water repellent film 8. Thermally oxidized silicon obtained by thermally oxidizing a silicon substrate or a natural oxide film may be used as the base film.

Next, a water repellent film 8 made of perfluoropolyether was formed on the nozzle substrate 3 on which the base film was formed, by vapor deposition. The film was formed at 200 A for 1 minute by a resistance heating method. The substrate was not heated, no gas was introduced, and this film formation was performed when the degree of vacuum reached 3×10⁻³ Pa. The nozzle plate 12 on which the water repellent film 8 was formed was allowed to stand at a normal temperature (25° C.) for 24 hours for fixing. The water repellent film 9 inside the ejection port 7 tends to decrease in F concentration from the front surface side toward the back of the nozzle substrate 3.

Next, a protective tape was attached as the protective member 10 to the front surface of the nozzle substrate 3 on which the water repellent film 8 was formed. Next, plasma irradiation was performed from a side of the flow path substrate 1 of the nozzle plate 12. A plasma treatment apparatus (MAS-8220) manufactured by Canon Marketing Japan Inc. was used for plasma irradiation. Since it is necessary to expose the inside of the ejection port 7 to the plasma via the bent flow path, the substrate bias is not particularly required. Rather, since the temperature of the substrate tends to rise during the ashing treatment, there is concern about peeling of the protective tape, and thus it is preferable that there is no substrate bias. This time, as a plasma treatment method, oxygen plasma was set at 16° C. without the substrate bias.

For the ashing treatment time required to hydrophilize the water repellent film 9 inside the ejection port 7, surface analysis was performed by the pure water contact angle (measured using pure water with a contact angle meter manufactured by Kyowa Interface Science Co., Ltd.) and an XPS method. The results obtained are shown in the table of FIG. 4.

When the ashing treatment time is 10 minutes or more, the F (fluorine) atom concentration of the residual film 11 is 3% or less, and the pure water contact angle is 25° or less, which indicates that the film is sufficiently hydrophilized. On the other hand, it can be seen that in the residual film 11 in the case where the ashing treatment time is 1 minute or more and 10 minutes or less, the contact angle is lowered although some F atoms remain. It is assumed that this is because the ether bond of the perfluoroether was broken and the terminal of the water repellent film became a hydroxyl group. In a case where the F atom concentration of the water repellent film (the water repellent film 8) not subjected to the ashing treatment is defined as 1, the ratio of the F atom concentration of the residual film 11 after the ashing treatment time of 1 minute or more is 0.9 or less, and the contact angle is 50° or less.

The contact angle inside the ejection port 7 is not limited to the above numerical value and may be selected as appropriate depending on the type of ink, as long as it is sufficiently hydrophilized with respect to the contact angle on the front surface side of the nozzle substrate 3. However, if the plasma irradiation time is long, there is a concern that the protective member 10 may be damaged, and the protective member 10 may come off, and thus the water repellent film on the front surface of the nozzle substrate 3 may be hydrophilized. Therefore, it is preferable that the treatment time be as short as possible.

According to the results of this examination, the preferable plasma irradiation condition is 1 minute with no substrate bias and a substrate temperature of 16° C. Ejection evaluation using ink was performed using the liquid ejection head manufactured by the above method. As a result, the meniscus position was stabilized at the front surface of the ejection port, and good print quality could be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-046878, filed on Mar. 23, 2022, which is hereby incorporated by reference herein in its entirety.

What is claimed is:

1. A method for manufacturing a liquid ejection head including a substrate,
the substrate including a first surface, a second surface on a side opposite to the first surface, a liquid supply port that opens on the first surface, a liquid ejection port that opens on the second surface, and a flow path that connects the supply port and the ejection port to each other such that the supply port and the ejection port do not linearly communicate with each other in a direction intersecting with the first surface and the second surface,
the method for manufacturing a liquid ejection head including the substrate comprising:
a liquid repellent film forming step of forming a liquid repellent film made of perfluoropolyether on a front surface of the substrate;
a masking step of covering a surface of the liquid repellent film formed on the second surface in the liquid repellent film with a protective member; and
a plasma treatment step of generating plasma from a side of the first surface toward a side of the second surface through the flow path to remove the liquid repellent film,
wherein, in the plasma treatment step, a portion of the liquid repellent film which remains inside the ejection port of the substrate after the plasma treatment step is hydrophilized.

2. The method for manufacturing a liquid ejection head according to claim 1, wherein, in the plasma treatment step, application of a bias to the substrate for enhancing an effect of ions is not performed.

3. The method for manufacturing a liquid ejection head according to claim 1, wherein, in the plasma treatment step, plasma is generated by a gas containing oxygen atoms.

4. The method for manufacturing a liquid ejection head according to claim 1, wherein, in the plasma treatment step, plasma is generated at a predetermined temperature for activating radicals.

5. The method for manufacturing a liquid ejection head according to claim 1, wherein, in the plasma treatment step, an F atom concentration of the portion of the liquid repellent film which remains inside the ejection port after being hydrophilized is 0.9 or less in a case where an F atom concentration of the liquid repellent film formed on the second surface is defined as 1.

6. The method for manufacturing a liquid ejection head according to claim 1, wherein the flow path includes a portion extending in a direction parallel to the first surface and the second surface.

7. The method for manufacturing a liquid ejection head according to claim 1, wherein the supply port and the ejection port do not overlap each other when viewed in a direction perpendicular to the first surface and the second surface.

8. The method for manufacturing a liquid ejection head according to claim 1, further comprising:
a masking removing step of removing the protective member.

9. A liquid ejection head comprising:
a substrate,
wherein the substrate includes
a first surface,
a second surface on a side opposite to the first surface,
a liquid supply port that opens on the first surface,
a liquid ejection port that opens on the second surface,
a flow path that connects the supply port and the ejection port to each other such that the supply port and the ejection port do not linearly communicate with each other in a direction intersecting with the first surface and the second surface, and
a liquid repellent film formed on the second surface,
wherein a film formed inside the ejection port of the substrate has higher hydrophilicity than the liquid repellent film.

10. The liquid ejection head according to claim 9, wherein the film formed inside the ejection port of the substrate is formed to be continuous with the liquid repellent film.

11. The liquid ejection head according to claim 9, wherein an F atom concentration of the film formed inside the ejection port of the substrate is 0.9 or less in a case where an F atom concentration of the liquid repellent film is defined as 1.

12. The liquid ejection head according to claim 9, wherein the flow path includes a portion extending in a direction parallel to the first surface and the second surface.

13. The liquid ejection head according to claim 9, wherein the supply port and the ejection port do not overlap each other in a case of being viewed in a direction perpendicular to the first surface and the second surface.
